(19) United States
(12) Patent Application Publication
(10) Pub. No.: US 2003/0070361 A1
(43) Pub. Date: Apr. 17, 2003

(54) Fuel processing system and method of purging a fuel processing system

(75) Inventor: Andreas Gubner, Burnaby (CA)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Generation Systems Inc., Burnaby (CA)

(21) Appl. No.: 09/981,304

(22) Filed: Oct. 15, 2001

(51) Int. Cl. C10J 1/00; B08B 5/00

(52) U.S. Cl. 48/61; 137/15.04

(57) ABSTRACT

A method of purging a fuel processing system comprising a steam reformer having a catalyst comprising nickel is provided. In one embodiment, the present method comprises supplying a purge gas to the steam reformer, the purge gas comprising an inert gas and hydrogen. A fuel processing system is also provided, the present system comprising: a steam reformer having a catalyst comprising nickel; means for supplying a purge gas at least to the reformer; and, a hydrogen supply for supplying hydrogen to the purge gas.

### BACKGROUND OF THE INVENTION

1. Field of the Invention

The present invention relates to fuel processing systems and methods of purging them. In particular, the present invention relates to methods and systems for purging employing a purge gas comprising an inert gas and hydrogen.

2. Description of the Related Art

Fuel processing systems are used in many industries for converting a fuel into a hydrogen-rich reformate. For example, fuel cell electric power generation systems employing fuels such as natural gas or methanol, for example, will employ a fuel processing system for converting the fuel to a hydrogen stream usable by the fuel cell stack.

Typical fuel processing components include reformers, such as steam reformers, for example, and may also include shift reactors and/or selective oxidizers. On shutdown, fuel processing systems are typically purged of reactant gases, including residual fuel, reformate and other reaction products, to reduce deterioration of the components that can occur. The presence of reactants at lower temperatures can result in carbon deposition and/or water condensation on the catalyst bed(s) of the component(s) and carbonyl formation, for example.

Purging is typically performed using an inert gas stream, such as steam and/or nitrogen. At normal operating temperatures for steam reformers employing nickel catalysts (above 700° C.), steam purging causes the oxidation of nickel to nickel oxide (NiO). In addition, depending on the catalyst formulation, inactive spinel formation is also a concern.

On start-up, the catalyst is usually reduced again to nickel. Where spinel formation is a concern, catalyst activity may be recovered by operation at higher temperatures with introduced hydrogen. However, there is concern that repeated oxidation and reduction of the catalyst leads to premature degradation. This is particularly a concern for fuel cell power generation systems in intermittent use applications because of repeated start-stop cycles. Accordingly, the use of steam purging in applications where the fuel processing system is frequently started and shut down is less than desirable.

Conventional fuel cell electric power generation systems typically employ pressurized nitrogen supplied from a nitrogen gas cylinder for purging. This approach undesirably increases the size and weight of the overall electric power generation system and requires maintenance to exchange an empty gas cylinder with a new one. Further, the operating cost of the electric power generation system is increased due to the expense of the inert gas supply. And, as with steam purging, there may be trace levels of oxygen in the steam reformer that can oxidize the catalyst as well.

It would be desirable to purge a fuel processing system without exposing nickel-based steam reforming catalysts to repeated reduction and oxidation cycles. It would also be desirable to reduce or avoid the use of pressurized nitrogen tanks for purging such fuel processing systems.

### BRIEF SUMMARY OF THE INVENTION

A method of purging a fuel processing system comprising a steam reformer having a catalyst comprising nickel is provided. In one embodiment, the present method comprises supplying a purge gas to the steam reformer, the purge gas comprising an inert gas and hydrogen.

A fuel processing system is also provided, the present system comprising: a steam reformer having a catalyst comprising nickel; means for supplying a purge gas at least to the reformer; and, a hydrogen supply for supplying hydrogen to the purge gas.

### BRIEF DESCRIPTION OF THE SEVERAL VIEWS OF THE DRAWINGS

FIG. 1 is a plot of in K against 1/T, for the equilibrium constants relating to the formation of nickel oxide (K₁) and the formation of water from hydrogen and oxygen (K₂).

FIG. 2 is a plot of the calculated activity of NiO in the presence of the different purge gas mixtures according to the present method within a temperature range of 400° C. to 900° C.

### DETAILED DESCRIPTION OF THE INVENTION

A method of purging a fuel processing system comprising a steam reformer having a catalyst comprising nickel is provided. In one embodiment, the present method comprises supplying a purge gas to the steam reformer, the purge gas comprising an inert gas and hydrogen.

A fuel processing system is also provided, the present system comprising: a steam reformer having a catalyst comprising nickel; means for supplying a purge gas at least to the reformer; and, a hydrogen supply for supplying hydrogen to the purge gas.

Steam reformers typically have an operating temperature range of about 400° C. to about 900° C. Thus, at least initially, purging of the reformer occurs at these temperatures. As mentioned above, steam has been used as a purge gas. However, in this temperature range steam may oxidize catalysts such as steam reforming catalysts. Repeated oxidation and reduction of the catalyst may adversely impact its activity and/or lifetime, particularly in applications where the duty cycle of the fuel processing system is relatively short.

The oxidation of nickel in steam reforming catalyst, in the presence of steam, is governed by the following reactions.

Ni(s)+1/2O₂(g) [symbol] NiO(s) (1)

H₂(g)+1/2O₂(g) [symbol] H₂O(g) (2)

And these reactions can be combined into a single equation.

Ni(s)+H₂O(g) [symbol] NiO(s)+H₂(g) (3)

As can be seen from equation (3), the equilibrium of nickel catalyst oxidation is independent of pressure.

The corresponding equilibrium constants for reactions (1) and (2), respectively, are:

$$\begin{matrix}{K}_{1} = \frac{{a}_{NiO}}{{a}_{Ni} \sqrt{{a}_{{O}_{2}}}} & ( 4 ) \\ {K}_{2} = \frac{{a}_{{H}_{2} O}}{{a}_{{H}_{2}} \sqrt{{a}_{{O}_{2}}}} & ( 5 )\end{matrix}$$

where a₁ are the individual activities of the reactants.

The equilibrium constants depend only on temperature and are available from the literature. In the temperature range of interest (400° C.-900° C.), they can be approximated as follows.

K₁(T)=e^{(28,339K/T-10.345)} (6)

and

K₂(T)=e^{(29,607K/T-6.408)} (7)

To determine whether nickel oxide formation occurs during steam purging, the activity of NiO needs to be calculated. To do so, equilibrium calculations are

a_{NiO}=K₁\sqrt{a_{O}_{₂}} (8)

performed based on the initial assumption that nickel in the catalyst is stable, i.e., the activity of Ni(s) is equal to 1. Then, equation (4) can be rewritten.

If the calculated activity of NiO is less than 1, then the initial assumption is correct and NiO formation does not occur. If the calculated activity of NiO is equal to 1, both solid phases will coexist, and some oxidation of the nickel will occur. If the calculated activity of NiO is greater than 1, the assumption that Ni(s) is stable is no longer true. Under conditions where the activity of NiO is greater than 1, Ni(s) will be oxidized to NiO.

In order to calculate the activity of NiO, it follows from equation (8) that the activity of oxygen must be determined. The relationship between the activities of the gaseous reactants and their mole fractions, assuming ideal gas behavior, is given by the equation:

$${a}_{i} = {x}_{i} \frac{p}{{p}^{0}} \qquad ( 9 )$$

where x₁ is the mole fraction of the reactant, p is pressure, and p⁰ is the reference pressure.

Hence, equation (5) can be rewritten as

$${K}_{2} = \frac{{X}_{{H}_{2} O}}{{X}_{{H}_{2}} \sqrt{{a}_{{O}_{2}}}} \qquad ( 10 )$$

Where the purge gas is pure steam, the mole fraction of steam approaches 1.

X_{H}_{₂}₀=1 (11)

Any oxygen and hydrogen present come from the dissociation of the steam, and the following relationship applies.

X_{H}_{₂}=2X_{O}_{₂} (12)

Substituting into equation (10) yields the following equation for the oxygen activity at p=p⁰.

$${a}_{{O}_{2}} = {( \frac{1}{2 {K}_{2}} )}^{2 / 3} \qquad ( 13 )$$

At temperatures between 400° C. and 900° C., the activity of NiO calculated from equations (13), (8) and (7) is several orders of magnitude greater than 1. Accordingly, the nickel catalyst in a steam reformer will be oxidized by a pure steam purge.

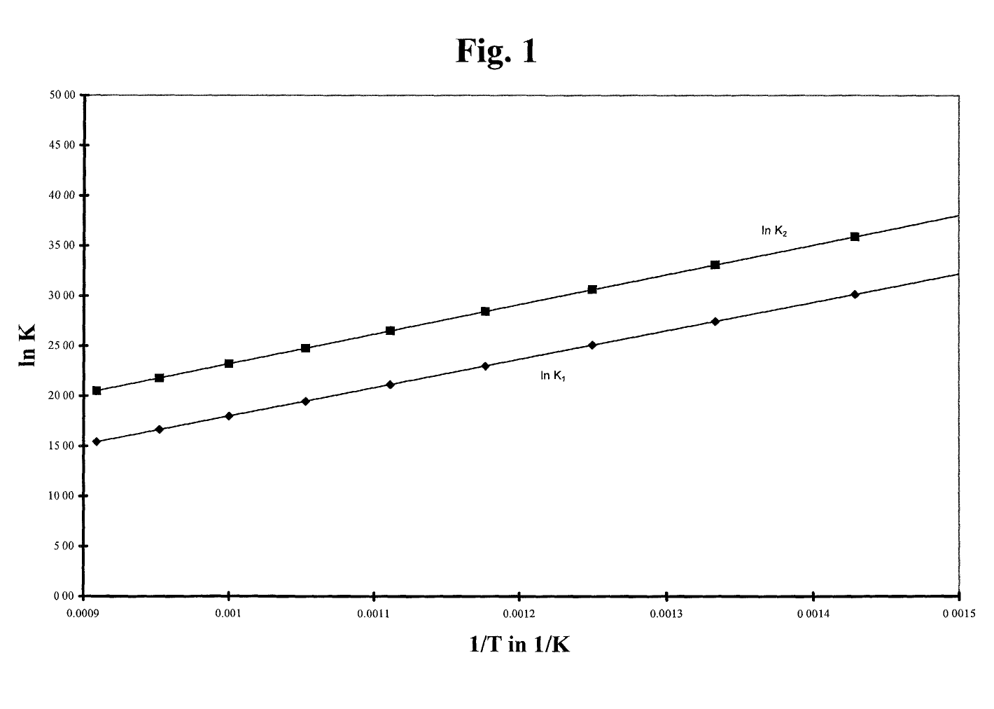

FIG. 1 illustrates the temperature dependency of equilibrium constants K₁ and K₂ in the temperature range of 400° C. to 900° C. (673 K to 1173 K). FIG. 1 is a plot of 1n K, as calculated from equations (6) and (7), respectively, against 1/T.

As indicated in FIG. 1, K₂ is larger than K₁ over the normal operating temperature range of steam reformers. Thus, during purging at these temperatures, the formation of steam is favored over formation of NiO. In other words, the affinity of hydrogen for oxygen is greater than the affinity of nickel for oxygen. This suggests that hydrogen acts as an efficient oxygen scavenger under such conditions.

Assuming a suitable excess of hydrogen, oxygen should be consumed by the hydrogen, thus protecting the nickel in the catalyst from oxidation. In this case, the mole fraction balance of gas in the reformer is

X_{H}_{₂}+X_{H}_{₂}_{O}=1 (14)

And equation (10) can be rewritten.

$${K}_{2} = \frac{( 1 - {X}_{{H}_{2}} )}{{X}_{{H}_{2}} \sqrt{{a}_{{O}_{2}}}} \qquad ( 15 )$$

Therefore, the oxygen activity depends greatly on the amount of hydrogen present. Note also that the mole fraction of hydrogen cannot be zero, because of the dissociation of steam. Under these circumstances, the oxygen activity is described by the following equation.

$${a}_{{O}_{2}} = {( \frac{( 1 - {X}_{{H}_{2}} )}{{X}_{{H}_{2}}} \cdot \frac{1}{{K}_{2}} )}^{2} \qquad ( 16 )$$

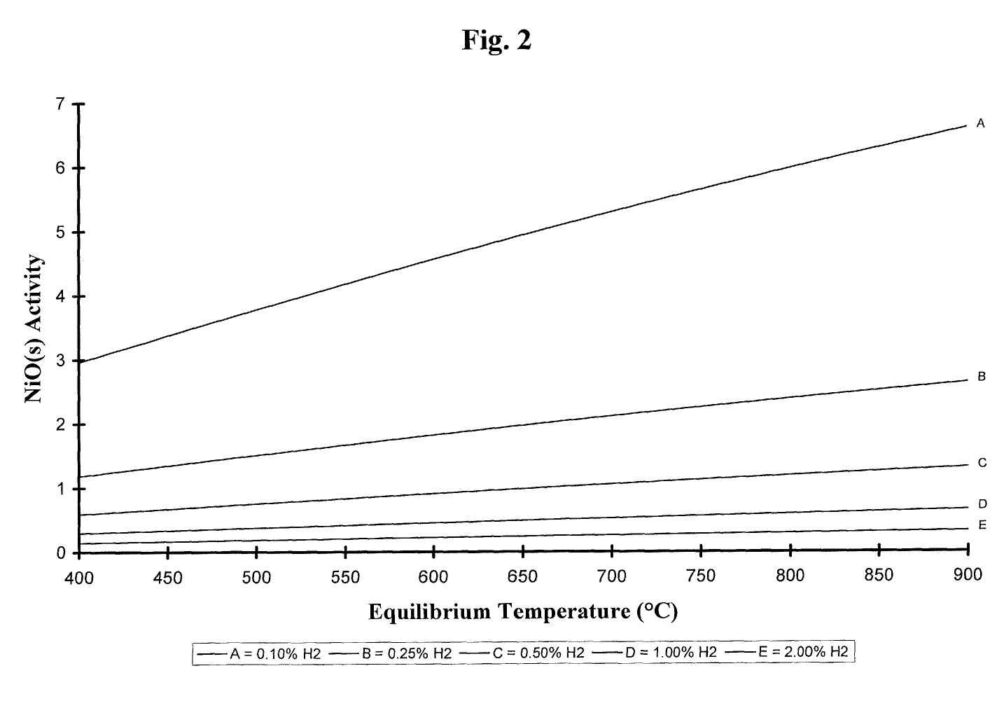

The activity of nickel oxide was calculated from equations (16) and (10) for steam purge gas mixtures having 0.10%-2.00% hydrogen, at temperatures in the range of 400° C. to 900° C. The results are illustrated in FIG. 2, which is a plot of the calculated activity of NiO in the presence of the different purge gas mixtures within the specified temperature range.

As indicated in FIG. 2, the oxidation of nickel catalyst during purging of a steam reformer is likely to occur unless greater than 0.25% hydrogen is added to the steam. Oxidation of the catalyst is likely prevented at temperatures above 650° C. when 0.50% hydrogen is added. Steam purge gas comprising 1% or more hydrogen may prevent oxidation of the catalyst over the entire temperature range.

In another embodiment of the present method, the purge gas supplied to the steam reformer comprises steam and greater than 0.25% hydrogen by volume. For example, the purge gas may have greater than 0.25% to about 2% hydrogen by volume. As another example, the purge gas may have at least 0.5% hydrogen by volume, and may have between about 0.5% and about 1% hydrogen by volume.

Where the purge gas comprises steam, conditions in the reformer should be controlled so as to avoid condensation of the steam onto the catalyst. Condensation is to be avoided as it can result in physical damage to the catalyst.

In another embodiment, the present method comprises supplying a purge gas comprising steam and hydrogen to the steam reformer, and maintaining the catalyst at a temperature above the condensation temperature of purge gas. In another embodiment of the present fuel processing system, the system further comprises means for maintaining the catalyst at a temperature above the condensation temperature of the purge gas. Suitable such means include, but are not limited to, resistive heating elements, heat exchangers, and burners. For example, the reformer catalyst bed may have resistive heating elements associated therewith for heating the bed. As another example, heat exchangers, such as coils or plates, could be employed. As a further example, in shell-and-tube steam reformer designs, for example, a burner may be employed to heat the tube(s) containing the catalyst. Other equivalent direct and indirect heating apparatus will be apparent to persons skilled in the art. The selection of particular means for maintaining the catalyst bed at a suitable temperature is not essential to the present method or fuel processing system, and persons skilled in the art can select suitable such means for a given application.

In another embodiment, the method further comprises adding another inert gas, such as nitrogen, to the purge gas. For example, the steam purge described in the preceding embodiment could be followed by a purge with nitrogen and hydrogen. As steam is removed from the reformer, the temperature of the catalyst bed could be reduced without the risk of condensation. This, in turn, may reduce the costs associated with maintaining the catalyst bed at a temperature above the condensation temperature of the purge gas. Alternatively, the reformer could be supplied with a purge gas comprising a mixture of steam, nitrogen (or other inert gas, such as argon, or carbon dioxide, for example) and hydrogen. Since the condensation temperature of the purge gas is determined by the partial pressure of steam, the addition of nitrogen will decrease the condensation temperature of the purge gas and may reduce the costs associated with maintaining the catalyst bed at a suitable temperature. At the same time, because nitrogen makes up only a portion of the purge gas, the size of the nitrogen supply for the fuel processing system may be reduced and/or the replacement interval may be increased, thus saving costs. As a further alternative, the amount of steam and dry inert gas may be varied over time to reduce the partial pressure of steam in the purge gas, thereby lowering the condensation temperature of the purge gas over time.

In another embodiment, the present method comprises supplying a purge gas comprising steam and hydrogen to the steam reformer, and reducing the pressure in the reformer. And in another embodiment of the present fuel processing system, the system further comprises a vacuum pump for reducing the pressure within the reformer. As the pressure in the reformer (and, optionally, other fuel processing components) decreases, the boiling point of water decreases, thereby decreasing the condensation temperature of the purge gas. For example, at a system pressure of 25 kPa, the condensation temperature of steam would be 65° C., and at a system pressure of 10 kPa, the condensation temperature of steam would decrease further to 46° C. If desired, a dry inert gas, such as nitrogen, may be added to the purge gas, in which case the condensation temperature of the purge gas would be further decreased. By reducing the pressure in the reformer, it may be possible to purge with steam and hydrogen while reducing or eliminating efforts to heat the catalyst bed and/or following with a nitrogen purge.

It is possible that other inert gases may also contain small amounts of oxygen as a contaminant. This presents a risk of oxidation of the nickel in steam reforming catalysts where such inert gases are used for purging. Thus, the present method may be employed in fuel processing systems that employ inert gases other than steam during purging. Non-limiting examples of suitable such inert gases include nitrogen, argon and carbon dioxide. In these circumstances, the amount of hydrogen to be added to the purge gas will depend on the concentration of oxygen. Persons skilled in the art can readily determine suitable concentrations of hydrogen to be added to the purge gas for a given application.

In an embodiment of the present fuel processing system, the means for supplying a purge gas to the reformer may supply an inert gas such as nitrogen, argon, carbon dioxide, and mixtures thereof. For example, a pressurized storage tank may be used to supply the purge gas. Alternatively, a downstream fuel processing component could supply an inert gas stream. For example, the fuel processing system could comprise a pressure swing adsorption unit (PSA). A PSA could generate a gas stream comprising nitrogen from air, for example, which could be supplied to the reformer during purging. As another example, the fuel processing system may employ a hydrogen separation membrane unit. The raffinate from such a membrane unit may comprise carbon dioxide and could also be supplied as the purge gas. As a further example, burner exhaust gas could be supplied as a purge gas, provided it is sufficiently oxygen-depleted.

In another embodiment of the present fuel processing system, the means for supplying a purge gas to the reformer comprises a vaporizer for supplying steam thereto. The vaporizer may be integrated into another fuel processing system component, such as the reformer, or it may be an independent component.

The selection of inert gas and means of supplying the purge gas to the reformer are not essential to the present method or fuel processing system, and depend on such factors as the size and composition of the system and its end use. Persons skilled in the art can select suitable inert gases and supply means for a given application.

In the present fuel processing system, hydrogen is supplied to the purge gas from a suitable hydrogen supply. For example, a pressurized hydrogen tank could be employed. Alternatively, a metal hydride container could be used. If desired, a portion of the hydrogen-rich stream from downstream fuel processing components could be diverted to the re-fill the hydrogen supply during normal operation. As a further alternative, the hydrogen supply could comprise one of the downstream fuel processing components. In this case, a portion of the hydrogen-rich stream could be diverted from the component and added to the purge gas directly, thereby reducing or eliminating the need for a hydrogen storage container.

While the present method has been described in relation to protecting steam reforming catalyst, it may also assist in protecting other oxidizable catalyst beds in fuel processing systems. It is believed that oxidation of such catalyst beds is negligible at temperatures under about 400° C., so this is primarily a concern for fuel processing components, such as reformers, that operate at or above that temperature. However, high-temperature shift reactors typically operate at temperatures between about 300° C. and about 450° C. Thus, during purging of fuel processing systems employing high-temperature shift reactors, the presence of hydrogen in the purge gas may assist in preventing oxidation of the shift catalyst bed, as well.

While particular elements, embodiments and applications of the present invention have been shown and described, it will be understood, of course, that the invention is not limited thereto since modifications may be made by those skilled in the art, particularly in light of the foregoing teachings. It is therefore contemplated that the appended claims cover such modifications as incorporate those features that come within the scope of the invention.

What is claimed is:

1. A method for purging a fuel processing system comprising a steam reformer, the reformer having a catalyst comprising nickel, the method comprising:
supplying a purge gas to the steam reformer, the purge gas comprising an inert gas and hydrogen.

2. The method of claim 1 wherein the inert gas comprises nitrogen and steam.

3. The method of claim 1 wherein the inert gas comprises nitrogen.

4. The method of claim 1 wherein the inert gas comprises steam.

5. The method of claim 4, further comprising maintaining the catalyst at a temperature above the condensation temperature of the purge gas.

6. The method of claim 4, further comprising reducing the pressure in the reformer.

7. The method of claim 6 wherein the pressure in the reformer is reduced to about 25 kPa.

8. The method of claim 6 wherein the pressure in the reformer is reduced to about 10 kPa.

9. The method of claim 1 wherein the purge gas comprises greater than 0.25% hydrogen by volume.

10. The method of claim 1 wherein the purge gas comprises at most about 2% hydrogen by volume.

11. The method of claim 1 wherein the purge gas comprises at least about 0.5% hydrogen by volume.

12. The method of claim 1 wherein the purge gas comprises about 0.5% to about 1% hydrogen by volume.

13. A fuel processing system comprising:
(a) a steam reformer having a catalyst comprising nickel;
(b) means for supplying a purge gas at least to the reformer; and
(c) a hydrogen supply for supplying hydrogen to the purge gas.

14. The fuel processing system of claim 13 wherein the purge gas comprises steam and the means for supplying a purge gas comprises a vaporizer.

15. The fuel processing system of claim 13 wherein the means for supplying a purge gas comprises a nitrogen tank.

16. The fuel processing system of claim 13, further comprising heating means for maintaining the catalyst at a temperature above the condensation temperature of the purge gas.

17. The fuel processing system of claim 13, further comprising a vacuum pump fluidly connected to the reformer for reducing the pressure therein.
